(19) United States
(12) Patent Application Publication
(10) Pub. No.: US 2014/0108101 A1
(43) Pub. Date: Apr. 17, 2014

(54) Distributed Corporate Performance Network

(71) Applicant: Gregory Vincent Pagendam-Turner, Calamvale (AU)

(72) Inventor: Gregory Vincent Pagendam-Turner, Calamvale (AU)

(21) Appl. No.: 13/651,485

(22) Filed: Oct. 15, 2012

(51) Int. Cl. G06Q 10/06

(52) U.S. Cl. CPC G06Q 10/06393
USPC 705/7.39

(57) ABSTRACT

The distributed corporate performance network is built on an ad-hoc basis to enable the immediate development of a practical support tool that allows a business manager at any level to

### TECHNICAL FIELD

This invention relates to a process for coordinating the definition and collection of key performance indicators using an Internet based system.

### BACKGROUND ART

There are a number of challenges for firms attempting to implement performance management systems:
1. The need to gain access to an organisation's various data stores.
2. One of the other key challenges with business intelligence is then gaining access to the data of suppliers and customers up and down the supply chain for the purposes of improving the performance of the business.
3. Requires a substantial investment in equipment, training and consulting even just to do a proof of concept.

### DISCLOSURE OF INVENTION

### Technical Problem

Typical performance management systems require access to large disparate data sources to provide the information required to calculate the actual values to be reported to management on performance management reports. Corporate data systems are usually designed to facilitate the day to day transactional and operating requirements of the business for a particular functional area. These systems are designed more for transactional volume rather than flexibility. Business performance management has more of a strategic and cross-functional focus. Extracting data from a firm's IT systems to provide performance targets and associated actual values can require considerable time and effort.

### Technical Solution

This invention addresses this problem by avoiding integration with existing information technology systems altogether. A central computer system provides senior management with a means of setting performance targets at the highest level of the business. These targets can then be delegated to subordinates down the organisational structure as required. The lower levels of the organisation are responsible for reporting their progress towards these targets on a regular basis. The values reported can then be automatically combined to provide a high level indication of the progress of the business towards its strategic goals.

The distributed corporate performance network is built on an ad-hoc basis to enable the immediate development of a practical support tool that allows a business manager at any level to start tracking the performance of staff or suppliers.

The performance network is built via a web-based software application. The concept involves two different roles:

Requestor—This is the person who is requesting a result from a Performer

Performer—This is the person from whom the result is requested

The Result is a numerical target with a target date (such as a profit margin, revenue, service uptime, customer satisfaction).

Performers can divide up the Result and delegate these portions by requesting these partial results to be delivered by other performers.

To understand how this would work in a large corporation imagine that the Requestor is the Chief Executive Officer (CEO) and the Performer is the Chief Financial Officer (CFO). The Result in this case would be to increase operating profit by $10 M by the end of the financial year. The CEO requests the CFO to deliver the Result by logging into the Performance Network web portal and specifying the result along with the email address of the Performer using a form similar to the one in FIG. 1.

The Result the CEO requires has now been delegated to the CFO.

The CFO can then break that result down into 2 sub-results:

1. Reduce costs by $2M

2. Increase sales by $8M

The CFO also determines a formula for combining the sub results into the original result:

Increased Profit=Cost Reduction+Increased Sales

The CFO can then delegate the first result to his Financial Controller (FC) and the second result to the Chief Marketing Officer (CMO) using the formula:

Similarly the FC can delegate his result to each department head (including the CMO).

Cost Reduction=Sum(Reduce costs by 10% in each department)

The CMO can also delegate pieces of his result to his sales managers

Increased Sales=Sum(Increase sales in each region by 20%)

This way a computation network is built up to support the original result in the organization.

Using a centralized server could also allow the performance network to extend beyond the corporate boundary and into the world of the supplier. Extending the above example:

The manager of the online widget sales division could delegate some of his result to his preferred supplier:

Increased Sales=min(Increased Orders, Available Stock)

Delegate to Supplier:

Available Stock=Increase by 10%

Ultimately a Result will not be delegated. In that case the Performer is responsible for entering their progress into the portal. These entries trigger an update to the calculated Results up the hierarchy. This gives the CEO real-time progress information for the whole organisation. The resulting Performance Network is represented in FIG. 2.

The CEO can monitor the CFO's performance in lifting net profit by tracking their progress online via their mobile phone as per FIG. 4.

CALCULATION ENGINE

The KPI Information is stored in a sharded NoSQL database. This is to make the sure that the system is sufficiently scalable.

Another aspect that is important to scalability is the efficiency of the calculation engine. The calculation engine stores values in a collection of nodes in the NoSQL database. Each node has a unique address based on the shard that it was created for and the timestamp for when it was created. Each node has a set of timestamped values, owner, access control list and a list of triggers. Calculated nodes also have a formula.

When a KPI is delegated, new nodes are added to the database for each delegate KPI. The delegated nodes then have a trigger added to them that triggers the recalculation of the parent node. This in turn could trigger the recalculation of its parent nodes should it have any.

To prevent an endless recalculation the addition of circular references in KPI delegation formulas is detected and reported to the KPI owner and calculation is halted.

SECURITY

Individual reads and writes to nodes are secured by an SSL style certificate over TLS.

A user will need to sign on to the web site to gain access. The user will need to use their corporate email address to identify as a corporate user. The portion of the email after the @ sign will be used to identify the organisation.

The user when signing in can make use of a ‘Remember Me’ option. Choosing this option will create a cookie on the client side that can be used to access the site for a period of two weeks without signing in. To modify or create KPIs the user will still need to authenticate the session via their password.

The password will be stored as a one way hash in the database.

The NoSQL database will be secured in an internal network behind a firewall.

The values of individual nodes may only be accessed by the creator or any other people that have been given access via the access control list. There are two kinds of access. Read access enables the user to query the specific value. Write access enables the user to change a formula for delegated KPIs or to change the value for a terminal node.

EXTERNAL SERVICE PROVIDER

The system enables values for KPIs to be provided from other automated systems. These systems will need to connect via SSL and using username and password credentials.

### Advantageous Effects

The Chief Executive Officer of a business can initiate a business performance management process within their business within hours without requiring any integration with other information technology systems within the business.

Managers have the flexibility to define performance indicators which may not have parallels in the firm's information technology systems.

Managers can delegate business targets to suppliers outside the organisation and make these suppliers responsible for entering their progress towards these targets in the system.

### DESCRIPTION OF DRAWINGS

FIG. 1 illustrates the basic web form for defining Key Performance Indicators (KPIs).

FIG. 2 illustrates a KPI being delegated.

FIG. 3 illustrates the distributed performance network of the delegated KPI.

FIG. 4 illustrates a scenario for monitoring a KPI by a CEO on their mobile phone.

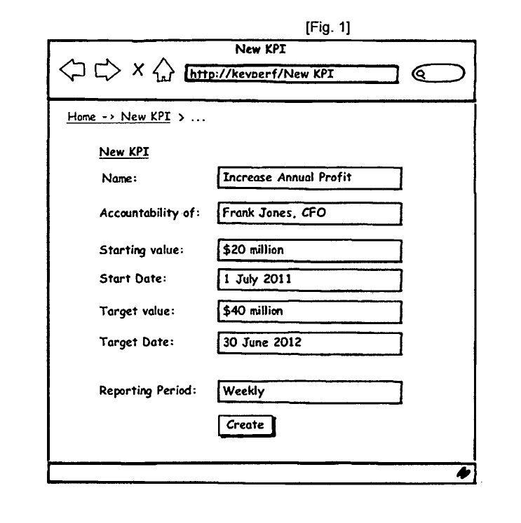

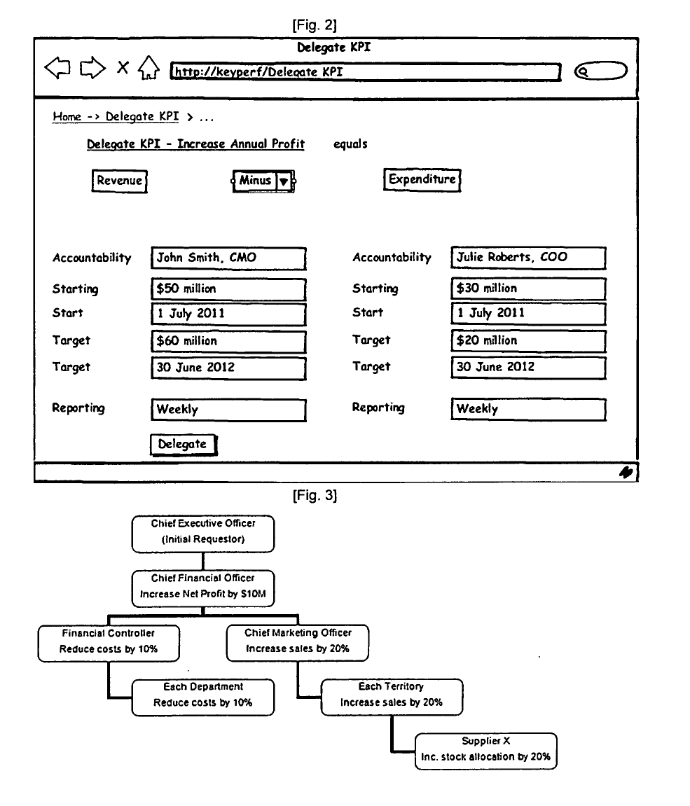

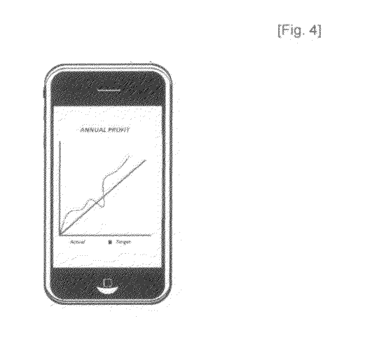

1. A method to construct a distributed performance network that extends beyond the corporate boundary that is updated in real-time.

2. The method of claim 1, wherein the user can establish performance targets via a web form.

3. The method of claim 1, wherein the user can delegate responsibility for achieving performance target to a subordinate or an external service provider.

4. The method of claim 1, wherein actual performance values are captured on a regular basis and then reported in realtime.
